(19) United States
(12) Patent Application Publication
(10) Pub. No.: US 2011/0231330 A1
(43) Pub. Date: Sep. 22, 2011

(54) JOB MATCHING METHOD

(75) Inventors: CHENG-HSING HSU, CHUNG LI (TW); YUH-SHOW TSAI, CHUNG LI (TW); CHING-JUNG LIAO, CHUNG LI (TW)

(73) Assignee: CHUNG YUAN CHRISTIAN UNIVERSITY, CHUNG LI (TW)

(21) Appl. No.: 13/051,086

(22) Filed: Mar. 18, 2011

(30) Foreign Application Priority Data
Mar. 19, 2010 (TW) 099108114

(51) Int. Cl. G06Q 10/00

(52) U.S. Cl. 705/321

(57) ABSTRACT

A job matching method that matches applicants with employers is revealed. The job matching method includes steps of providing a plurality pieces of capability information of a job seeker, creating a capability map by quantifying the pieces of capability information, and matching the capability map with a plurality of recruitment requirements. Thus the job applicant's capabilities are shown by the capability map clearly and the employers find qualified candidates more quickly. The length of the interview is reduced and the recruitment period is minimized. Therefore, the recruitment is more efficient.

### BACKGROUND OF THE INVENTION

1. Fields of the Invention

The present invention relates to a job matching method, especially to a job matching method that links job seekers with employers faster and better by capability maps.

2. Descriptions of Related Art

A traditional job search and recruiting includes searching for and applying jobs by means of newspaper/magazine job advertisements and employment agencies. This is not only costly but also time-consuming for both job seekers and employers and such efforts will not always result in immediate results.

Nowadays a plurality of recruitment websites matches job seekers with employers based on skills and requirements. The advertisements are posted online and candidates apply online. The employers input positions and requirements while job applicants input their profiles and preferences so as to refine the search and increase the matching speed. Moreover, employers/job seekers get instant e-mail notification when new jobs posted match the profiles. This allows job seekers and employers to be matched instantly so that the average matching time is minimized and the cost per hire is down. However, it takes time for job seekers to look for available positions and minimize the search scope by repeatedly manual operations. As to the employers, they may get a stack of unqualified candidates and need time to sift the candidates for the job. Moreover, the employee recruited by such way may be not competent to deal with the work. For example, many positions are just for new or recent graduates. Although the employers believe that graduates can apply knowledge and skills learned in school to the work, there are quite a few graduates not good in their majors. Thus there is a need for schools to train the graduates to be more competent. It is also an important issue for students in school to understand their strengths and weakness well so that they can improve their skills and give full play to their advantages in their positions in future.

In order to overcome shortcomings of conventional job matching methods, a new job matching method of the present invention has been developed. Instead of words or scores, a radar capability map is used to represent the job applicant's core skills or student's learning results. Through a quantification process, job applicant's capabilities or academic scores are converted into data to create the capability map. Thus employers can use the maps as references to evaluate the job applicants. The capability map is also useful in school course designs or company's internal training and development programs. Therefore, what students have learned in school matches employers' requirements and graduates can enter the job market smoothly. The employers/applicants can find suitable candidates/positions easily and quickly.

### SUMMARY OF THE INVENTION

Therefore it is a primary object of the present invention to provide a job matching method that helps employers find qualified candidates by a capability map quickly. Less time is spent per candidate and the recruitment time is reduced so that the recruitment is more efficient.

It is another object of the present invention to provide a job matching method that makes a job seeking process easier and faster by a capability map demonstrating competencies of job applicants got at work or learned in school. Thus the employers and the job applicants (even new graduates without working experience) can find their perfect match.

It is a further object of the present invention to provide a job matching method in which both employers and job applicants can understand the strengths and weakness of the job applicants through a capability map created by a plurality of course capability indices. Moreover, schools can teach students or companies can train candidates according to the capability map.

In order to achieve above objects, a job matching method of the present invention includes a plurality of steps: providing a plurality pieces of capability information of a job seeker, creating a capability map according to the pieces of capability information, and matching the capability map with a plurality of recruitment requirements. Thus the job seeker's capabilities are represented by the capability map fairly and objectively and the employers can find the talent more effectively. The interview is shortened and the recruitment period is reduced so that the recruitment is more efficient. In the step of creating a capability map according to the pieces of capability information, the pieces of capability information are quantified so as to create the capability map. The step of quantifying the pieces of capability information to create the capability map further consists of the steps of: converting the pieces of capability information into a plurality of parameters; and quantifying the parameters to create the capability map. Moreover, the step of converting the pieces of capability information into a plurality of parameters further includes a step of setting a plurality of course capability indices and a plurality of course weights. The parameters are generated according to these course capability indices and the course weights. Thereby the capabilities of the job seeker are represented by the capability map (graphics) and this is over the limit of a single course/capability displayed by scores/words. Furthermore, job applicants are matched with available positions according to the capability map. The job matching process is completed in a fair and objective manner.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a flow chart of an embodiment according to the present invention;

FIG. 2 is a flow chart of another embodiment according to the present invention;

FIG. 3A is a mapping table of an embodiment according to the present invention;

FIG. 3B is a mapping table of an embodiment according to the present invention;

FIG. 4 is a weight table of an embodiment according to the present invention;

FIG. 5 is a parameter table of an embodiment according to the present invention;

FIG. 6 is a capability map of an embodiment according to the present invention;

FIG. 7 is a schematic drawing showing structure of an embodiment of a job matching system according to the present invention.

### DETAILED DESCRIPTION OF THE PREFERRED EMBODIMENT

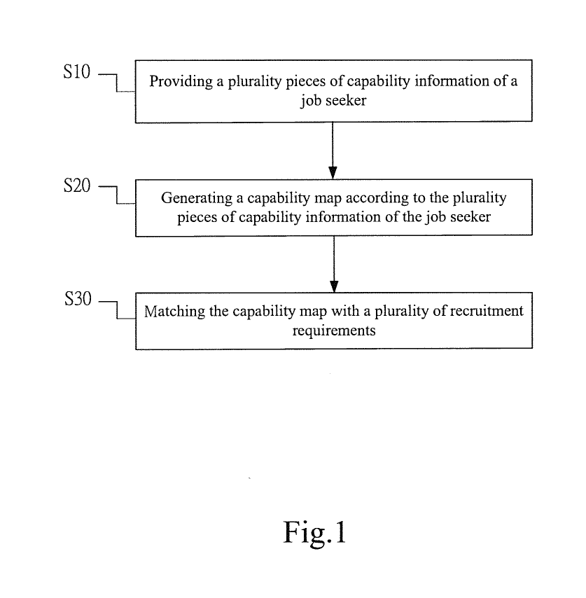

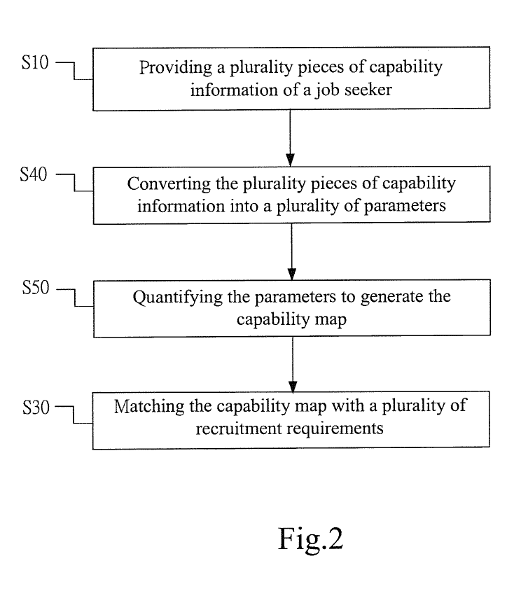

Refer to FIG. 1 and FIG. 2, flow charts of embodiments according to the present invention are disclosed. As shown in the step S10, provide a plurality pieces of capability information of a job seeker firstly. Job seekers can provide the plurality pieces of capability information by themselves. For new graduates, the capability information is what they have learned in school. Refer to the step S20, create a capability map according to the pieces of capability information. The present invention quantifies the pieces of capability information so as to create a capability map. As shown in the step S30, match the capability map with a plurality of job requirements. For example, a job board matches job seekers with job requirements for positions according to the capability map created by the present invention. The job applicant can build his own capability map according to skills and characters he has while the employers provide position descriptions such as characters, skills, etc. Then both parties can easily get matched results instantly through the job board. The capability map is established through a plurality of processes according to the information of job seekers' capabilities, not only simply selecting options in a list. Thus the employers can access qualified candidates by the capability map of the present invention and interviews are more focused with less time. The recruitment is time-saving and efficient. Therefore, the present invention is a more efficient recruitment solution. The details of how the capability maps of the job seekers and employers' recruitment needs are matched are described in the embodiments.

Moreover, job applicants such as new graduates create their capability map gradually during school days. This school-day capability map also helps employers find prospective candidates (qualified workers) in an efficient manner. How the job seekers build their school-day capability maps is described in following details. The capability maps of the present invention can be applied to job seekers with working experience or graduates looking for their first job.

The step S20 of creating a capability map according to the pieces of capability information further consists of two steps—step S40: convert the plurality pieces of capability information into a plurality of parameters and step S50: quantify the parameters so as to create a capability map. Take a capability map of a new graduate during his school days as an example. In the step S40, the plurality pieces of capability information is converted into a plurality of parameters according to a plurality of course weights. The parameters are corresponding to a plurality of course capability indices of the capability map and the capability information includes academic records (scores). Thereby the capabilities of the job seeker are displayed by graphics and this is over the limit of course grade recorded as numbers or words. The job seeker's capability is presented in a more solid way.

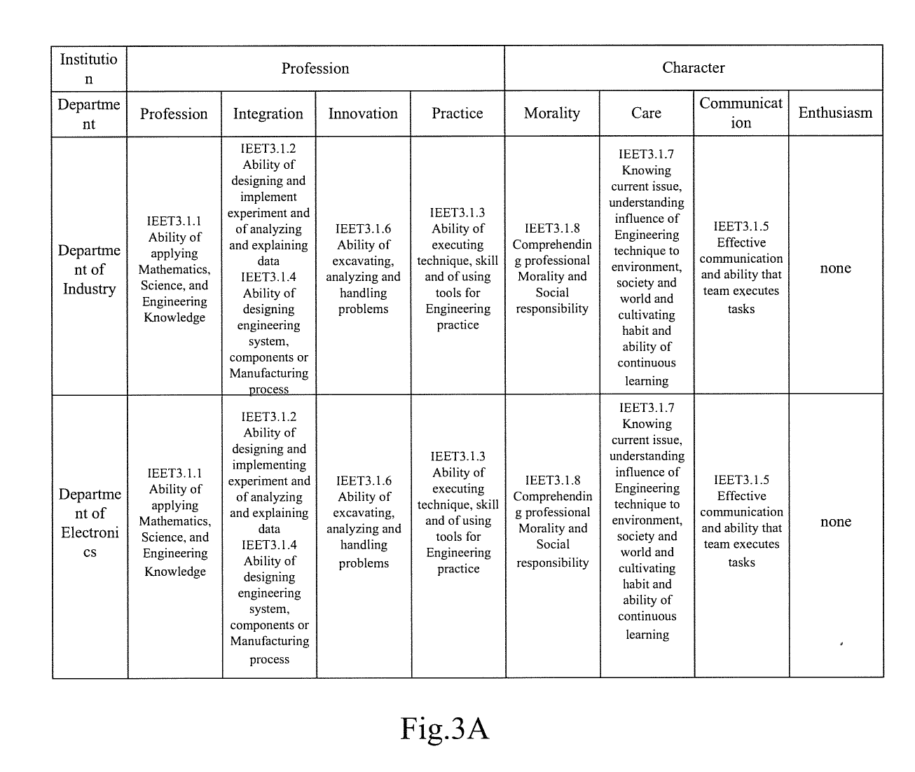

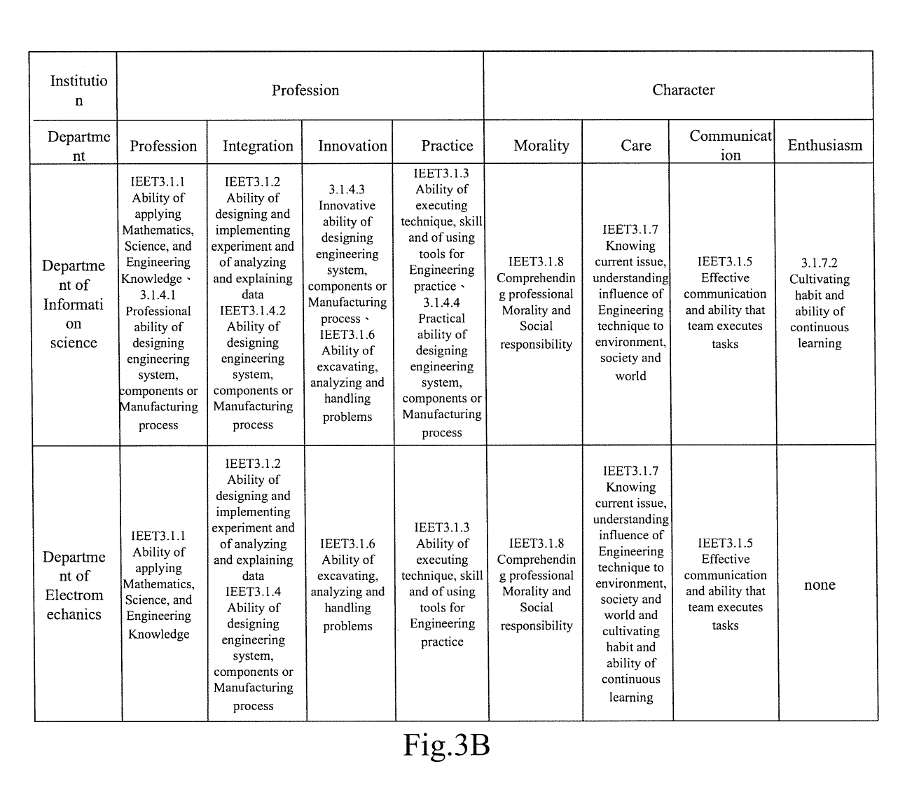

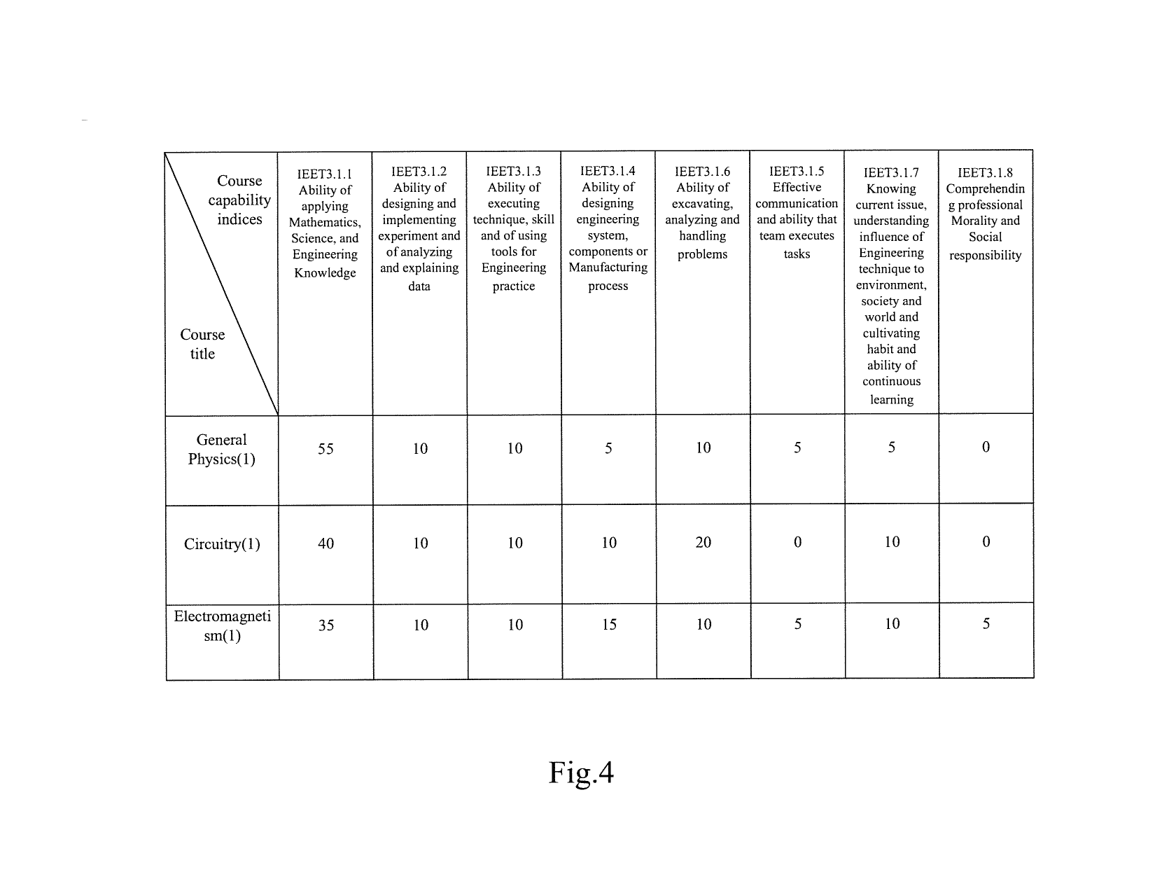

Refer to FIGS. 3A, 3B and FIG. 4, mapping tables and a weight table of an embodiment of the present invention are revealed. As shown in figures, take accreditation criteria of Institute of Engineering Education Taiwan (IEET) as an example. This is not intended to limit the scope of the invention. In the job matching method according to the present invention, the step of converting the capability information into a plurality of parameters further includes a step of generating a plurality of course capacity indices according to both the parameters and the corresponding course weights. The capability map includes a plurality of basic capability indices and each basic capability index includes at least one course capability index. The basic capability index is generated by the course capability index or indices according to a mapping table. These basic capability indices are composed of a capability of professional knowledge, a capability of integrating and adapting knowledge, a capability of innovation and problem solving, a capability of practical application, a capability of social responsibility and ethics, a capability of caring, a capability of compassion and stress management, and a capability of communication and cooperation. These basic capability indices are either related to professions or character. In this embodiment, eight basic capability indices are preferred while the number of the basic capability index is not limited. Then the course weights corresponding to each course capability index are assigned according to course contents and key capabilities required.

For example, for students taken the “Intermediate Accounting” course, the course focuses on the capability of professional knowledge in order to get accounting licenses and work as accounting staffs. If a student takes a general education course—“basic singing skill”, the general education course is only for releasing stress so that this course, the related basic and course capability indices should focus on character. Thus the present invention produces the capability map that shows not only job seekers' professional capabilities but also their character and personality. Nowadays employees the companies looking for are not only with professional competencies, but also good character. For example, in the research and development (R&D) department, staffs work as a team. Thus the communication capability is far more important than others. The employers can get the best candidates for their positions according to this basic capability index in the capability map of the present invention. Compared with the present invention, traditional employers can only observe the candidates during the trial period. Therefore, the best candidates are selected with less time and fewer interviews by the present invention. The total time spent sorting and interview is shortened and the recruitment efficiency is improved.

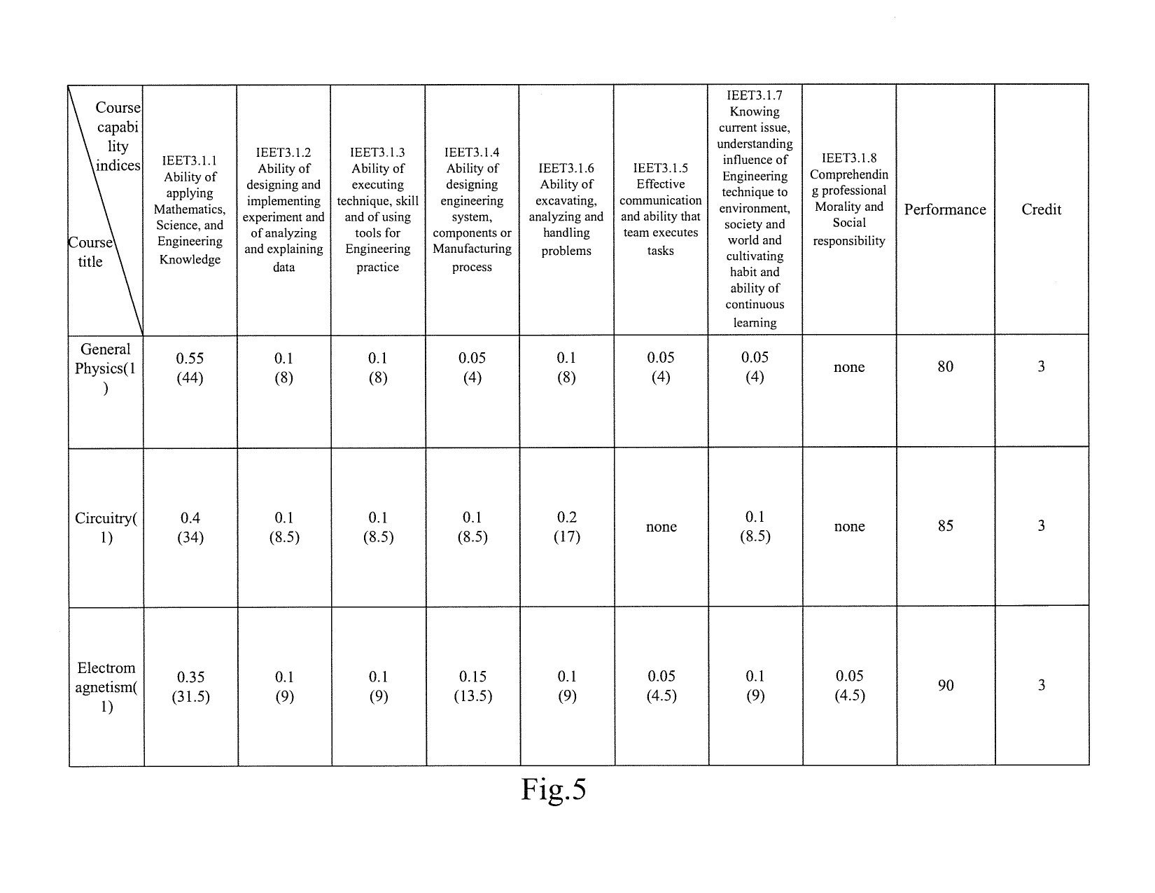

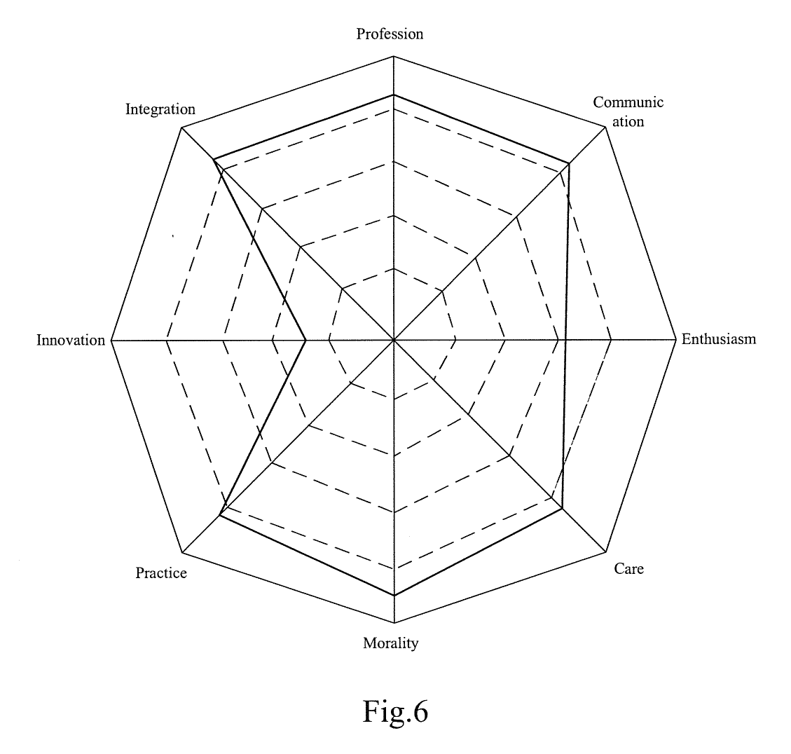

Refer to FIG. 4, FIG. 5 and FIG. 6, weight tables and a radar chart of an embodiment are disclosed. After converting the pieces of capability information into a plurality of parameters, the job matching method of the present invention includes a step of quantifying the parameters to create a capability map. The parameters are quantified by the following equation:

$$\frac{\sum {W}_{i} {C}_{i} {S}_{i}}{\sum {W}_{i} {C}_{i} \times 100}$$

wherein Wᵢ is course weight, Cᵢ credit and Sᵢ is score (grade).

At first, each course receives a series of course weights according to the course capability indices. As shown in FIG. 4, each row of numbers represents course weights of a course assigned according to the course capability indices. For example, General Physics (I) that is assigned with a series of course weights, 55, 10, 10, 5, 10, 5, 5, respectively corresponding to the course capability index. The course weights of Electric Circuit (I) as well as Electromagnetics (I) are also allocated according to the course capability indices in a similar way. In order to create the capability map by quantification of the equation, the ratio between the course weight of each course capability index and total course weights of the course capability indices the General Physics (I) received is calculated so as to get a plurality of parameters, as numbers in the brackets shown in FIG. 5.

For example, a student Mr. Wang has taken three courses such as General Physics (I), Electric Circuit (I) and Electromagnetics (I) in a semester. As shown in FIG. 4, the weight chart shows each course and related weights assigned according to course capability indices. Refer to the cell of IEET3.1.1 in FIG. 4 and FIG. 5, the course weight of General Physics (I) is 55 with 3 credit points and the score is 80. Substitute these parameters into the equation for calculation. The course weight of Electric Circuit (I) is 40 with 3 credit points and the score is 85. Electromagnetics (I) has a course weight of 35, 3 credit points and the score is 90. Substitute these parameters into the equation and 0.84 (84%) is obtained. (44*3+34*3+31.5*3)/[(0.55*3+0.4*3+0.35*3)*100]=0.84. Next, refer to the cell of IEET3.1.2, for Mr. Wang, the course weight of General Physics (I) is 10 with 3 credit points and the score is 80. The course weight of Electric Circuit (I) is 10, 3 credit points and the score is 85. The course weight of Electromagnetics (I) is 10, 3 credit points and the score is 90. Substitute these parameters into the equation and 0.82 (82%) is obtained. (8*3+8.5*3+9*3)/[(0.1*3+0.1*3+0.1*3)*100]=0.82. In a similar way, the value of percentage for the cell of IEET3.1.3 (practice), EET3.1.4 (integration), IEET3.1.6 (innovation), IEET3.1.5 (communication), IEET3.1.7 (caring), IEET3.1.8 (ethics) corresponding to the axes on the radar chart are 82%, 84%, 28%, 83%, 83% and 90% respectively. Refer to FIG. 6, the radar charts have multiple axes and each is corresponding to and labeled with one basic capability index.

The value of 0.84 is plotted along the axis of profession on the radar chart The value of 0.82 is plotted along the axis of integration on the radar chart. Each value is plotted along the corresponding axis of the radar chart and then a line is drawn connecting the value for each spoke. The radar chart is completed. This radar chart is Mr. Wang's radar chart of that semester. The failed required subjects (courses) are still calculated at first. After taking the failed subjects again and obtaining higher score, the old score is replaced by the new one.

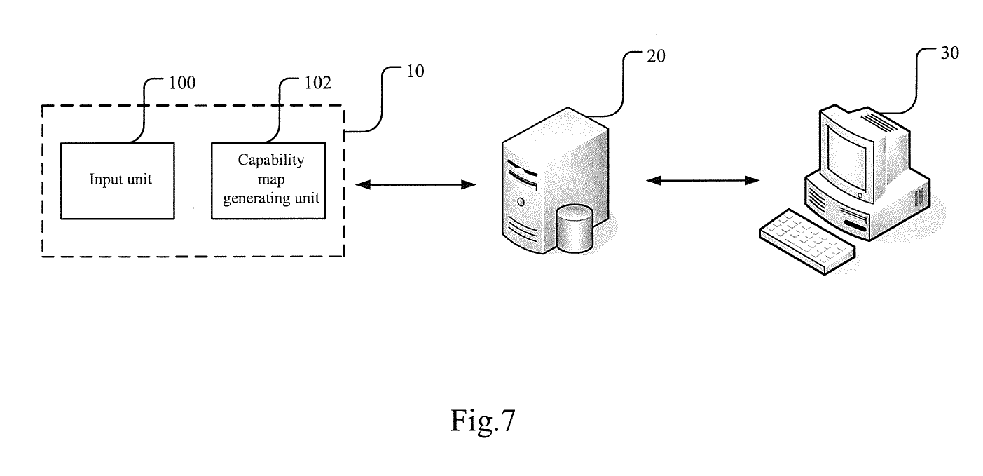

Refer to FIG. 7, an embodiment of a job matching system according to the present invention is revealed. As shown in figure, the job matching system of the present invention includes at least one job applicant's computer 10, a server providing human resource services 20, and at least one employer's computer 30. The job applicant's computer 10 consists of an input unit 100 and a capability map generating unit 102. The input unit 100 is for the job applicant (seeker) to input a plurality pieces of capability information. The capability map generating unit 102 coupled with the input unit 100 is for creating a capability map according to the capability information input by the job applicant. The capability map of the job applicant generated is uploaded to the server providing human resource services 20 by the job applicant's computer 10. The server providing human resource services 20 having a human resource database (not shown in FIG. 200 for storage of at least one job applicant's capability map is coupled to least one employer's computer 30. The employer produces a piece of manpower requirement related information according to capabilities labeled on the capability map by the employer's computer 30 and then the piece of manpower requirement related information is transmitted to the server providing human resource services 20. After receiving a plurality of applicants' capability maps and a plurality pieces of manpower requirement related information, the server providing human resource services 20 matches the capability maps with the manpower requirement related information so as to find suitable candidates.

Back to FIG. 6, the percentage value of each basic capability index is shown on the capability map (radar map) of the job applicant. Thus the employer can set values of the basic capability indices and evaluate applicants according to these values. For example, once employers require the employees to have the capability of professional knowledge (profession), the capability of integrating and adapting knowledge (integration), the capability of compassion and stress management, and the capability of communication and cooperation, all over 60%, the server providing human resource services 20 searches the job applicant's information in the human resource database to get qualified candidates. In this embodiment, the job applicant's capability map in the FIG. 6 meets the requirements of the employer so that this capability map is transmitted to the employer's computer 30 for assessment.

In summary, the present invention provides a job matching method that includes a plurality of steps. Firstly, provide a plurality pieces of capability information of a job applicant. Then create a capability map according to the pieces of capability information. And match the capability map with a plurality of recruitment requirements set by employers. Thus the job applicant's capabilities are represented by the capability map concretely and the employer can find the qualified candidates quickly. Less time is spent per job applicant and the recruitment time is reduced so that recruitment efficiency is improved. Moreover, the job seeker's capabilities are displayed by graphics (the capability map) and this is over the limit of each course/skill displayed by scores/words. The job applicant's capabilities are displayed in a more solid way.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A job matching method comprising the steps of:
providing a plurality pieces of capability information of a job seeker;
creating a capability map according to the plurality pieces of capability information of the job seeker; and
matching the capability map with a plurality of recruitment requirements.

2. The method as claimed in claim 1, wherein in the step of the creating a capability map according to the plurality pieces of capability information of the job seeker, the plurality pieces of capability information is quantified so as to create the capability map.

3. The method as claimed in claim 1, wherein in the step of providing a plurality pieces of capability information of a job seeker, the plurality pieces of capability information is provided by the job seeker himself.

4. The method as claimed in claim 1, wherein in the step of providing a plurality pieces of capability information of a job seeker, the plurality pieces of capability information is obtained while the job seeker was in school.

5. The method as claimed in claim 1, wherein the step of creating a capability map according to the plurality pieces of capability information of the job seeker further includes steps of:
converting the plurality pieces of capability information into a plurality of parameters; and
quantifying the parameters to create the capability map.

6. The method as claimed in claim 5, wherein in the step of converting the plurality pieces of capability information into a plurality of parameters, the plurality pieces of capability information is converted into the plurality of parameters according to a plurality of course weights; the plurality of parameters are corresponding to a plurality of course capability indices of the capability map.

7. The method as claimed in claim 6, wherein the step of converting the plurality pieces of capability information into a plurality of parameters further includes a step of:
generating the plurality of course capability indices according to the plurality of parameters and the plurality of course weights corresponding to the parameters.

8. The method as claimed in claim 6, wherein the capability map includes a plurality of basic capability indices and each basic capability index includes at least one course capability index.

9. The method as claimed in claim 8, wherein the course capability index generates the basic capability index according to a mapping chart.

10. The method as claimed in claim 9, wherein the basic capability indices include a professional knowledge capability, an integrating and adapting capability, an innovation and problem solving capability, a practical application capability, a social responsibility and ethics capability, a capability of caring, an enthusiasm and stress management capability, and a communication and cooperation capability.

11. The method as claimed in claim 1, wherein the plurality pieces of capability information includes a plurality pieces of score information.

12. The method as claimed in claim 1, wherein the capability map includes a radar chart.
